(19) United States
(12) Patent Application Publication
(10) Pub. No.: US 2002/0012799 A1
(43) Pub. Date: Jan. 31, 2002

(54) Lithographic plate material

(75) Inventors: Hironori Sato, Saitama-shi (JP); Junichi Nouda, Tokyo (JP); Toshimichi Katsuoka, Tokyo (JP)

Correspondence Address: LORUSSO & LOUD, 3137 Mt. Vernon Avenue, Alexandria, VA, 22305, US

(73) Assignee: KIMOTO CO., LTD.

(21) Appl. No.: 09/880,860

(22) Filed: Jun. 15, 2001

(30) Foreign Application Priority Data
Jun. 19, 2000 (JP) 2000-182898

(51) Int. Cl. B32B 1/00

(52) U.S. Cl. 428/409

(57) ABSTRACT

There is provided a lithographic plate material with which a lithographic plate is prepared by the hot-melt transfer recording method utilizing an ink ribbon. The lithographic plate material has an image-receptive layer for hot-melt transfer recording that has water retention property or can be imparted with water retention property on a support, and the image-receptive layer has surface roughness (JIS-B0601-1994) of 0.15 μm or more in terms of arithmetical mean deviation Ra and 1.00-3.00 μm in terms of 10-point height of irregularities Rz. It shows good transfer property for ink layer of ink ribbon and excellent fixation property for ink layer, and it enables production of a printing plate having excellent printing durability.

### BACKGROUND OF THE INVENTION

The present invention relates to a material for producing a lithographic plate (also referred to as “printing plate” hereinafter) by the hot-melt transfer recording method utilizing a hot-melt transfer recording medium (ink ribbon).

Recently, there have been proposed plate making methods in which image signals from computers are directly outputted on a printing plate material by using a digital outputting machine equipped with a thermal head or infrared semiconductor laser, without outputting the image signals on a photographic paper or lithographic film. As one of such direct plate making methods, a plate making method based on the hot-melt transfer recording method utilizing a hot-melt transfer recording medium (ink ribbon) is known (Japanese Patent Laid-open Publication (Kokai) No. 10-16420 etc.).

In the hot-melt transfer using an ink ribbon, if transfer property or fixation property for ink layer are not sufficient, there are caused problems due to insufficient printing durability of printing plate, such as white omissions in solid image portions and omission of small dots or fine lines, when a lithographic plate material is used for plate making and then printing as a printing plate. Therefore, it is desirable that lithographic plate materials have good transfer and fixation properties for ink layer of ink ribbon. However, surfaces of lithographic plate materials are generally made to have unevenness of a certain degree in order to impart water retention property, and such unevenness may be a cause for the degradation of ink transfer property for the ink layer of ink ribbon. Moreover, when there is used a material of which surface is preliminarily subjected to a hydrophilization treatment to eliminate the necessity of desensitization after plate making (referred to as a material of “non-etch type” hereinafter), the fixation property for ink layer of ink ribbon is degraded, and there remains a problem of the aforementioned degradation of printing performance.

On the other hand, ink ribbons with a very thin ink layer have come to be used as ink ribbons in the hot-melt transfer recording method in order to attain printing with high resolution. And it can be considered that, also in the plate making method utilizing the hot-melt transfer recording method, printed matters of high resolution can be obtained by using such an ink ribbon having a very thin ink layer.

However, if such an ink ribbon having an extremely thin ink layer is used for the transfer on a lithographic plate material having unevenness on its surface as described above, there are caused a problem that the transfer property is degraded, that is, protruding portions penetrate the ink layer, and thus there are caused white omissions in solid image portions in printed matters and the protruding portions in the non-image portions scrape the ink layer surface to cause scumming in printed matter corresponding to the protruding portions in the non-image portions and so forth, and hence good printed images cannot be obtained.

In particular, this problem observed in image portions is particularly serious in the non-etch type material which includes a thermosetting water-soluble resin as a binder of the image-receptive layer. It is considered that this is because the unevenness is scarcely flattened by heat and pressure of a thermal head used for the transfer of ink layer in a material utilizing a thermosetting water-soluble resin, while the unevenness may be flattened to a certain extent by heat and pressure in a material utilizing a thermoplastic resin.

Therefore, an object of the present invention is to provide a lithographic plate material that shows good ink layer transfer property and excellent ink layer fixation property and hence enables production of a printing plate having excellent printing durability even if ink ribbon having a very thin ink layer is used. Another object of the present invention is to provide a lithographic plate material that shows excellent water retention property, does not require desensitization treatment after plate making, and shows excellent fixation property for ink layer.

### SUMMARY OF THE INVENTION

In order to achieve the aforementioned objects, the inventors of the present invention assiduously studied the surface conditions of lithographic plate materials. As a result, they found that, while the water retention property showed correlation with arithmetical mean deviation Ra, which is a generally used parameter for surface roughness, and good water retention property could be obtained in a certain range of arithmetical mean deviation Ra depending on the material constituting the image-receptive layer, the mean surface roughness Ra was not necessarily reflected in quality of the transfer property for ink layer of ink ribbon, but it showed correlation with 10-point height of irregularities Rz, and good transfer and fixation properties could be obtained and water retention property could also be secured within a certain rage of 10-point height of irregularities Rz. Thus, they accomplished the present invention.

Specifically, the lithographic plate material of the present invention is a lithographic plate material having an image-receptive layer for hot-melt transfer recording formed on a support, the image-receptive layer having water retention property or capable of being imparted with water retention property, wherein the image-receptive layer has surface roughness (JIS-B0601-1994) of 0.15 μm or more in terms of arithmetical mean deviation Ra and 1.00-3.00 μm in terms of 10-point height of irregularities Rz.

In the lithographic plate material of the present invention, the image-receptive layer may contain a hydrophilic polymer binder and a surface roughening agent having an average particle diameter of 1.5-2.5 μm. Further, in the lithographic plate material of the present invention, the hydrophilic polymer binder may be a crosslinked hydrophilic polymer compound.

In the lithographic plate material of the present invention, the surface roughness of the image-receptive layer, in particular, the 10-point height of irregularities Rz, is selected to be within a specific range. This makes it possible to secure water retention property of the surface, and provide excellent transfer and fixation properties of the hot-melt transfer recording medium (ink ribbon). Thus, there can be obtained a printing plate showing excellent printing durability. In particular, it shows excellent transfer property for ink layer of ink ribbon even when the ink layer is a small thickness, and therefore it can provide a lithographic plate that provides printed images of high resolution.

### PREFERRED EMBODIMENT OF THE INVENTION

Hereafter, the lithographic plate material of the present invention will be explained in detail.

The lithographic plate material of the present invention has a structure comprising a support and an image-receptive layer formed on the support, which enables hot-melt transfer recording utilizing an ink ribbon.

Usable support may be a plastic film composed of a resin such as polyethylene, polypropylene, polyvinyl chloride, polystyrene, polyethylene terephthalate, waterproof paper having such a plastic film laminated thereon or waterproof paper coated with such a resin.

A polyethylene terephthalate film is particularly preferred in view of its mechanical strength, dimensional stability, resistance to chemicals and waterproof property. The support may be a film made of a resin mixed with a light-shielding pigment such as carbon black and titanium oxide in order to impart light-shielding property. While the thickness of the support it not particularly limited, there is generally used one having a thickness of 50 μm to 300 μm.

In order to improve adhesion to the image-receptive layer, the support may be subjected to a plasma treatment, colona discharge treatment or far ultraviolet ray exposure. As a treatment for easy adhesion between the support and the image-receptive layer, an undercoat layer may be provided.

The undercoat layer is preferably composed of a resin showing good adhesion to both of the support and the image-receptive layer. Therefore, the resin of the undercoat layer may differ depending on the kind of the resins used for the support and the image-receptive layer. Examples thereof include polymers and copolymers of vinyl acetate, vinyl chloride, styrene, butadiene, acrylic esters, methacrylic esters, ethylene, acrylonitrile and so forth, water-insoluble polymers such as polyester resins, polyurethane resins, alkyd resins and epoxy resins, water-soluble polymers such as polyvinyl alcohol, carboxymethyl cellulose, hydroxyethyl cellulose, casein, gelatin and water-soluble polyurethane and so forth. These resins maybeusedeach aloneorin combination of two or more kinds of them.

The undercoat layer is formed by applying a coating solution containing such a resin on a support. The thickness is not particularly limited, but it is usually 0.5 μm to 10 μm after it is dried.

The undercoat layer may contain additives such as electric conduction agents, colorants, surfactants and crosslinking agents, as required.

The image-receptive layer should have surface roughness of 0.15 μm or more, preferably 0.25 μm or more, in terms of the arithmetical mean deviation Ra, and 1.00-3.00 μm, preferably 1.50-2.50 μm, in terms of the 10-point height of irregularities Rz.

The arithmetical mean deviation Ra means a value obtained as a uniform height of peaks and valleys existing on a surface roughness curve of an evaluation length, which is obtained by dividing an integral of the absolute values of the peak and valley heights with the evaluation length. The 10-point height of irregularities Rz is obtained as follows. That is, a surface roughness curve of an evaluation length, which length is N times long as a sampling length equal to a cutoff value, is divided into N of equal sections. For each section, Rz′ is obtained as a difference of an average height of peaks having heights of first place to fifth place and an average height of valleys having depths of first place to fifth place. The 10-point height of irregularities Rz is obtained as an arithmetic average of N of Rz′.

Such surface roughness of the image-receptive layer determines the transfer and fixation properties for ink layer of ink ribbon and ability to retain fountain solution (water retention property). When the arithmetical mean deviation Ra is less than 0.15 μm, sufficient wafer retention property cannot be obtained in a printing plate produced from the material, and hence scumming is generated.

Further, if the 10-point height of irregularities Rz exceeds 3.00 μm, good transfer property for ink layer cannot be obtained. As a result, white omissions in solid image portions and so forth may be caused, and scumming of non-image portions may be generated due to rubbing by the ink ribbon. The surface roughness of the image-receptive layer is also defined by the 10-point height of irregularities Rz for the following reasons. That is, when the surface roughness is defined only by the arithmetical mean deviation Ra in a certain range, a surface having peaks (protruding portions) having a height significantly higher than the defined Ra value may be included in the defined surface, if the integrated area is small. And, if an ink layer is transferred on a surface having such peaks (protruding portions), the peaks (protruding portions) penetrate the ink layer, and thus the ink layer is not transferred for such portions. On the other hand, if the surface roughness is also defined by the 10-point height of irregularities Rz, the defined surface would not have peaks having a height extremely higher than the defined Rz value, and therefore good transfer property for ink layer can be secured by selecting the value to be within a proper range.

However, if the 10-point height of irregularities Rz in less than 1.00 μm, the fixation property for ink layer is degraded and thus sufficient printing durability cannot be obtained. Therefore, it should be 1.00 μm or more.

The image-receptive layer having such surface conditions may contain a hydrophilic polymer binder, inorganic microparticles for imparting water retention property and a surface roughening agent for imparting the aforementioned predetermined surface roughness.

Examples of the hydrophilic polymer binder include hydrophilic polymer binders such as polyvinyl alcohol, carboxymethyl cellulose, hydroxyethyl cellulose, polyvinylpyrrolidone and methyl vinyl ether/maleic anhydride copolymer. In order to further improve wafer proof and mechanical strength of the image-receptive layer, it is desirable to use known crosslinking agents such as melamine resins, epoxy resins, polyisocyanates, aldehyde compounds and silane compounds in combination. Particularly preferred is completely saponified polyvinyl alcohol crosslinked with tetraalkoxysilane hydrolysate as a crosslinking agent having a polymerization degree of less than 1000.

In order to improve water retention property, waferproof and mechanical strength, the image-receptive layer may further contain a resin emulsion such as emulsions of homopolymers and copolymers of vinyl chloride, vinyl acetate, acrylic esters, ethylene, styrene and so forth besides the aforementioned hydrophilic polymer binder so long as the hydrophilicity is not degraded.

The inorganic microparticles are added in order to enhance the water retention property of the image-receptive layer by imparting fine unevenness.

Examples of such inorganic microparticles include those of zinc oxide, calcium carbonate, barium sulfate, silica, titanium oxide, clay, kaoline, aluminium hydroxide, alumina, and so forth. A combination of titanium oxide, colloidal silica and/or colloidal alumina is particularly suitable.

Further, the inorganic microparticle preferably have an average particle diameter of less than 1 μm, more preferably less than 0.2 μm. By using those having an average particle diameter of less than 1 μm, the surface area of the image-receptive layer can be sufficiently increased, and thus its water retention property for fountain solution can be improved without degrading waterproof.

In order to obtain the aforementioned effect, the inorganic microparticles are preferably used in an amount of 150 parts by weight or more, more preferably 300 parts by weight or more, per 100 parts by weight of the binder resin. However, if the amount of the inorganic microparticles is unduly increased, the coated film becomes brittle, which leads to degradation of printing durability and so forth. Therefore, the amount is preferably 1000 parts by weight or less, more preferably 900 parts by weight or less.

Examples of the surface roughening agent for imparting the predetermined surface roughness to the image-receptive layer include inorganic microparticles such as those of calcium carbonate, barium sulfate, clay, silica and alumina, synthetic resin microparticles such as those of acrylate resins, epoxy resins, nylon resins, polyethylene resins, fluorocarbon resins, and benzoguanamine resins and so forth. Among these, those of silica, especially amorphous silica, are preferred, and those having an average particle diameter of 1.0-3.0 μm, preferably 1.5-2.5 μm, are used. Furthermore, those having narrow particle size distribution are preferred.

If the average particle diameter exceeds 3.0 μm, or if the particle size distribution is broad and particles having a large particle diameter are contained, even though the average particle diameter is small, the 10-point height of irregularities Rz exceeds 3.0 μm, and hence good transfer property for ink layer cannot be obtained. Further, if the average particle diameter is less than 1.0 μm, most of the particles are buried in the resin constituting the image-receptive layer, and sufficient fixation property for ink layer cannot be obtained.

The amount of the surface roughening agent is 5-100 parts by weight, preferably 10-60 parts by weight, per 100 parts by weight of the binder resin constituting the image-receptive layer.

Besides the binder resin, inorganic microparticles and surface roughening agent mentioned above, the image-receptive layer may further contain additives such as electric conduction agents, colorants and surfactants, as required, in an amount that does not degrade the aforementioned performance.

The lithographic plate material of the present invention can be prepared by applying a coating solution containing the materials constituting the image-receptive layer on a support directly or after a coating solution containing a resin constituting the undercoat layer is coated and dried to form an undercoat layer, and drying the coated image-receptive layer. When polyvinyl alcohol to be crosslinked with tetraalkoxysilane hydrolysate is used as the hydrophilic polymer binder of the image-receptive layer, a dispersion containing polyvinyl alcohol and inorganic microparticles in an alcohol and wafer as solvents is prepared beforehand, and then mixed with tetraalkoxysilane hydrolysate and a surface roughening agent to form a coating solution for image-receptive layer. An image-receptive layer containing crosslinked polyvinyl alcohol as the hydrophilic polymer binder can be formed by applying the above coating solution to a support or an undercoat layer and drying it.

Although the thickness of the image-receptive layer is not particularly limited, it is preferably in the range of 1-10 μm, more preferably 3-7 μm. With a thickness of 1 μm or more, the image-receptive layer can have the water retention property, transfer property and fixation property for ink layer, and with a thickness of less than 10 μm, flexibility of the image-receptive layer can be maintained.

The lithographic plate material of the present invention can also be provided with a layer for imparting various functions such as an antistatic layer and anti-curl layer on the surface of support opposite to the surface provided with the image-receptive layer.

The lithographic plate material of the present invention is made into a printing plate by forming lipophilic transferred images of on the hydrophilic image-receptive layer by the hot-melt transfer recording method utilizing a hot-melt transfer recording medium (ink ribbon). The image portions serve as ink-receiving portions that repel water and carry ink, and the non-image portions where transferred images are not formed serve as hydrophilic portions that carry fountain solution and repel ink.

The hot-melt transfer recording medium (ink ribbon) is formed by providing a lipophilic ink layer having a thickness of 0.5-4 μm on a polyester film support having a thickness of 3-6 μm. The ink layer comprises wax having a melting point of 60-120° C. such as paraffin wax, micro wax, polyethylene wax, carnauba wax, candelilla wax, montan wax and lanolin wax, a resin having a softening point of 60-200° C. such as polyester resins, acrylate resins, urethane resins, ethylene vinyl acetate resins, amide resins andpolyterpene resins, a coloring pigment such as carbon black, and a dispersing agent.

The ink ribbon may have an overcoat layer on the ink layer in order to improve adhesion of the image-receptive layer of the present invention and the ink layer and to improve the transfer property of the ink layer.

Because the lithographic plate material of the present invention has specific surface roughness, in particular, 10-point height of irregularities Rz within a specific range, even if an ink ribbon having an ink layer with a thickness of about 1 μm is used, the ink layer is not broken by unevenness, and the hot-melt transfer ink layer can be surely and firmly fixed on the uneven surface. Thus, a printing plate showing excellent printing durability and high resolution can be obtained.

### EXAMPLES

Hereafter, example of the lithographic plate material of the present invention will be explained. In the following examples, “part” and “%” are used on a weight basis unless otherwise indicated.

### Example 1

On a support consisting of a white polyester film having a thickness of 125 μm, an undercoat layer was formed by applying a coating solution having the following composition so that the coated layer have a dry film thickness of 5 μm.

| | |
|---|---|
| <Coating solution for undercoat layer> | |
| Polyester resin (Elitel UE3201, | 10 parts |
| Unichika, Ltd.) | |
| Isocyanate prepolymer | |
| (solid content: 60%, Takenate D110N, | |
| Takeda Chemical Industries, Ltd.) | 2 parts |
| Toluene | 40 parts |
| Methyl ethyl ketone | 40 parts |

Then, Dispersion A for image-receptive layer having the following composition was prepared, and Coating solution B for image-receptive layer was further prepared by using Dispersion A, coated on the aforementioned undercoat layer, and dried to form an image-receptive layer having a thickness of 7 μm. Thus, a lithographic plate material was obtained.

| <Dispersion A for image-receptive layer> | | |
|---|---|---|
| Inorganic microparticles | 30 | parts |
| (titanium oxide, | | |
| average particle size: 0.12 μm, | | |
| FA55W, FURUKAWA CO., LTD.) | | |
| Inorganic microparticles | 3 | parts |
| (colloidal silica, primary | | |
| particle size: 12 nm, Aerosil 200, | | |
| Nippon Aerosil Co., Ltd.) | | |
| Polyvinyl alcohol (10% aqueous solution, | 100 | parts |
| Gosenol NL05, The Nippon Synthetic | | |
| Chemical Industry Co., Ltd.) | | |
| Isopropyl alcohol | 40 | parts |
| Distilled water | 100 | parts |
| <Coating solution B for image-receptive layer> | | |
| Dispersion A for image-receptive | 100 | parts |
| layer | | |
| Surface roughening agent | 1 | part |
| (amorphous silica, average particle | | |
| diameter: 1.9 μm, Sylysia 530, | | |
| Fuji Silysia Chemical Ltd.,) | | |
| Tetraalkoxysilane hydrolysate | 15 | parts |

The tetraalkoxysilane hydrolysate was obtained by mixing the following components to cause hydrolysis reaction at room temperature for 24 hours.

| | |
|---|---|
| Tetraethoxysilane | 100 parts |
| (regent, Wako Pure Chemical | |
| Industries, Ltd.) | |
| Ethanol | 100 parts |
| 0.1 N Aqueous hydrochloric acid | 200 parts |

### Comparative Example 1

A lithographic plate material was obtained in the same manner as in Example 1 except that the surface roughening agent was not added in the preparation of Coating solution B for image-receptive layer.

### Comparative Example 2

A lithographic plate material was obtained in the same manner as in Example 1 except that the surface roughening agent was changed as described below in the preparation of Coating solution B for image-receptive layer.

| <Coating solution B′ for image-receptive layer> | | |
|---|---|---|
| Dispersion A for image-receptive | 100 | parts |
| layer | | |
| Surface roughening agent | 1 | part |
| (silica, average particle | | |
| diameter: 3.0 μm, Sylysia 730, | | |
| Fuji Silysia Chemical Ltd.,) | | |
| Surface roughening agent | 1 | part |
| (silica, average particle | | |
| diameter: 6.0 μm, Sylysia 770, | | |
| Fuji Silysia Chemical Ltd.,) | | |
| Tetraalkoxysilane hydrolysate | 15 | parts |

The values indicating surface roughness (arithmetical mean deviation Ra and 10-point height of irregularities Rz) of the lithographic plate materials obtained in the example and the comparative examples are shown in Table 1.

TABLE 1

| | Ra | Rz |
|---|---|---|
| Example 1 | 0.35 | 2.00 |
| Comparative Example 1 | 0.13 | 0.89 |
| Comparative Example 2 | 0.58 | 3.67 |

[Transfer property]

Lithographic plates were prepared from the lithographic plate materials obtained in the example and comparative examples by outputting 3-18 point characters of Mincho typeface, screen tint images with 85 lines of 10%, 30%, 50% and 70% and black solid image as digital data using an ink ribbon hot-melt transfer printer utilizing a hot-melt transfer ink ribbon having an ink layer with a thickness of 1 μm and having a serial head of 600 DPI. As for these printing plates, the following Evaluation of printer output image (1) was performed. Then, printing was performed under the following conditions by using the above printing plates without desensitization treatment, and transfer property for ink layer was evaluated by performing Evaluation of white omission in solid image portion of printed matter (2) and Evaluation of scumming in non-image portion of printed matter due to rubbing by ribbon (3). The results are shown in Table 2.

Printing conditions:

Printing machine: Heidelberg Quick Master QM 46-1

Printing speed: 6000 sheets/hour

Paper: coated paper (OK Top Coat)

Ink: TK High Echo Sumi M: TOYO INK MFG. CO., LTD.

Fountain solution: Astro Mark 3, Nikken Kagaku Kenkyusho, diluted 50 times with tap water

Evaluation

(1) Evaluation of Printer Output Image

Evaluation ∘: White omissions were not observed in black solid image portions and black scumming was not also generated in non-image portions due to rubbing by ink layer on the aforementioned lithographic plates.

Evaluation ×: White omissions were observed in black solid image portions on the aforementioned lithographic plates, or black scumming was generated in non-image portions due to rubbing by ink layer.

(2) Evaluation of White Omission in Solid Image Portion of Printed Matter

Evaluation ∘: White omissions were not observed in black solid image portions of printed matter.

Evaluation ×: White omissions were observed in black solid image portions of printed matter.

(3) Evaluation of Scumming in Non-image Portion of Printed Matter Due to Rubbing by Ribbon

Evaluation ∘: Scumming due to rubbing by ribbon was not observed in non-image portions of printed matter.

Evaluation ×: Scumming due to rubbing by ribbon was observed in non-image portions of printed matter.

[Fixation Property]

Printing durability was examined by observing the printed matter prepared in the aforementioned evaluation of transfer property to evaluate fixation property of image-receptive layer for ink layer. The results are shown in Table 2.

Evaluation ∘: Characters of 3-18 points in Mincho typeface and screen tint images with 85 lines of 10%, 30%, 50% and 70% were sufficiently resolved and reproduced even when the number of printed sheets exceeds 5000.

Evaluation ×: Deletion was partially observed for characters in Mincho typeface and the screen tint images when the number of printed sheets reaches 100.

[Water Retention Property]

Water retention property of the image-receptive layer was evaluated by observing whether scumming due to insufficient water retention property was caused on the printed matter prepared in the aforementioned evaluation of transfer property. The results are shown in Table 2.

Evaluation ∘: Scumming due to insufficient water retention property was not generated at all on the 100th printed sheet of the printed matter.

Evaluation ×: Scumming due to insufficient water retention property was generated on the 100th printed sheet of the printed matter.

TABLE 2

| | | | | | Water retention |
|---|---|---|---|---|---|
| | Transfer property | | | | property |
| | Image | | Scumming in | Fixation | Scumming in |
| | reproducibility | | non-image | property | non-image |
| | on printed | White omission | portion by | Printing | portion on |
| Sample | matter | in solid image | rubbing | durability | printed matter |
| Example 1 | ∘ | ∘ | ∘ | ∘ | ∘ |
| Comparative | ∘ | ∘ | ∘ | X | X |
| Example 1 | | | | | |
| Comparative | X | X | X | ∘ | ∘ |
| Example 2 | | | | | |

As seen from the results shown in Tables 1 and 2, since both of the arithmetical mean deviation Ra and the 10-point height of irregularities Rz were small in the lithographic plate material of Comparative Examples 1, it did not show printing durability at all due to the bad fixation property for ink layer, while it showed good transfer property for ink layer. Further, when it was made into a printing plate, scumming was generated on non-image portions, because sufficient water retention property could not be obtained for the printing plate.

As for the lithographic plate material of Comparative Example 2, it showed good water retention property because the arithmetical mean deviation Ra was within the defined range. However, since the 10-point height of irregularities Rz was large, protruding portions penetrated the ink layer so that white omissions were generated in black solid image portions. In addition, protruding portions of non-image portions rubbed the ink layer to generate scumming. Because of these, white omissions and scumming were also generated on the printed matter.

On the other hand, the lithographic plate material of the example, which had an arithmetical mean deviation Ra and 10-point height of irregularities Rz within suitable ranges, showed good transfer property and fixation property for ink layer, and good water retention property when it was made into a printing plate.

What is claimed is:

1. A lithographic plate material comprising a support and an image-receptive layer for hot-melt transfer recording formed on the support, wherein the image-receptive layer has water retention property or can be imparted with water retention property on a support, and has surface roughness (JIS-B0601-1994) of 0.15 μm or more in terms of arithmetical mean deviation Ra and 1.00-3.00 μm in terms of 10-point height of irregularities Rz.

2. The lithographic plate material according to claim 1, wherein the image-receptive layer contains a surface roughening agent having an average particle diameter of 1.0-3.0 μm.

3. The lithographic plate material according to claim 1, wherein the image-receptive layer contains a hydrophilic polymer binder and a surface roughening agent having an average particle diameter of 1.5-2.5 μm.

4. The lithographic plate material according to claim 3, wherein the hydrophilic polymer binder is a crosslinked hydrophilic polymer compound.

5. The lithographic plate material according to claim 3, wherein the image-receptive layer contains 5-100 parts by weight of the surface roughening agent per 100 parts by weight of the hydrophilic polymer binder.
